(19) United States
(12) Patent Application Publication
(10) Pub. No.: US 2020/0190376 A1
(43) Pub. Date: Jun. 18, 2020

(54) CRASH DURABLE EPOXY ADHESIVE HAVING IMPROVED LOW-TEMPERATURE IMPACT RESISTANCE

(71) Applicant: Dow Global Technologies LLC, Midland, MI (US)

(72) Inventors: WENWEN LI, FREEPORT, TX (US); KRISHNAN BINDU, FREEPORT, TX (US); SONJA HIGGINS, FREEPORT, TX (US); ERIC E. COLE, AUBURN HILLS, MI (US); GARY L. JIALENELLA, AUBURN HILLS, MI (US); ANDREAS LUTZ, HORGEN (CH); MICHAEL T. MALANGA, MIDLAND, MI (US); EDDY I. GARCIA-MEITIN, FREEPORT, TX (US)

(21) Appl. No.: 16/341,106

(22) PCT Filed: Oct. 6, 2017
(86) PCT No.: PCT/US17/55479

§ 371 Date: Apr. 11, 2019

Related U.S. Application Data
(60) Provisional application No. 62/414,234, filed on Oct. 28, 2016.

(51) Int. Cl. C09J 163/00; C08G 65/332; B32B 7/12; B32B 15/04; B32B 15/18

(52) U.S. Cl. CPC C09J 163/00; C08G 65/3322; C08G 2650/06; B32B 15/043; B32B 15/18; B32B 7/12

(57) ABSTRACT

A one component epoxy adhesive composition is comprised of an epoxy resin, a polyurethane based toughener, an epoxy capped toughener comprised of a polymer backbone capped with an epoxy, wherein the polymer backbone is at least partially immiscible in the epoxy resin; and an epoxy curing agent. The one component adhesive composition may have improved impact resistance at low temperatures, such as −40° C. or less. The epoxy based toughener may be formed by reacting the hydroxyls of a polyol with a stoichiometric excess of cyclic anhydride to form a carboxylic acid capped polymer. The carboxylic acid capped polymer is then reacted with a stoichiometric excess of an epoxy resin having at least two epoxides to form the epoxy capped toughener having epoxide end groups.

### FIELD

The present invention relates generally to impact modifiers, and in particular, to a thermosetting epoxy resin having improved low-temperature impact resistance.

### BACKGROUND

Epoxy resin based adhesives are used to bond a variety of different substrates together. In certain applications, the adhesive must maintain good bonding to the substrate and good impact resistance over a very wide temperature range. For example, epoxy resin adhesives are used in the automotive industry metal-metal bonding in frame and other structures. Adhesive bonding can reduce the number of welds that are needed to construct the frame, and for that reason the use of these adhesives can reduce assembly costs. The adhesive will be subjected to a very wide range of temperatures during subsequent manufacturing processes and during the lifetime of the vehicle. These temperatures may be as high as 80° C. Automobiles that are used in cold climates may be exposed to temperatures as low as −40° C.

Structural adhesives potentially offer similar advantages in aerospace manufacturing as they do in the automotive sector-reduced vehicle weight and reduced manufacturing costs. However, aircraft are routinely exposed to temperatures as low at −60 to −70° C. when they operate at altitudes of 30,000 feet or more, which is common in the industry. Structural adhesives used in these applications must retain adequate adhesion and impact resistance at these temperatures.

Many structural adhesives used in automotive applications are based on a rubber-modified epoxy resin and a reactive “toughener”. Structural adhesives of these types are described in, for example, U.S. Pat. Nos. 5,202,390, 5,278,257, WO 2005/118734, U.S. Published Patent Application No. 2005/0070634, U.S. Published Patent Application No. 2005/0209401, U.S. Published Patent Application 2006/0276601 and EP-A-0 308 664. Unfortunately, these structural adhesives tend to exhibit a substantial drop in performance at temperatures of −40° C. or below. It would be desirable to provide a structural adhesive that has good adhesion and impact properties, and which retains those properties better at temperatures as low as −60 or −70° C.

U.S. Patent Publication No. 2011/0114257 describes an impact modifier containing carboxylic acid group(s), which is prepared from the reaction of an intramolecular anhydride of a di- or tricarboxylic acid with at least one amphiphilic block copolymer containing at least one hydroxyl group. The impact modifier is blended with an epoxy resin and is purported to provide improvements in impact resistance at temperatures above or approaching −40° C.

In WO 2005/007720 and US 2007/0066721, an adhesive system is described which contains a polytetrahydrofuran-based toughener based on polytetrahydrofuran (PTHF, also known as polytetramethylene glycol, PTMEG, polytetramethylene oxide, and PTMO). WO 2005/007720 and US 2007/0066721 describe tougheners based on PTHF polymers having various molecular weights. In those systems, the molecular weight of the PTHF is reported to have little impact on adhesive properties.

Recently, in application WO/2016/108958, amphiphilic block copolymers were described as tougheners for improving the impact resistance at less than minus 40° C., which may be terminated with hydroxyl or carboxylic acid groups. These tougheners, however, may suffer from reduced shelf life of the adhesive and only somewhat improved low temperature properties.

Thus it would be desirable to provide an adhesive composition having improved impact resistance at temperatures near and below minus 40° C. and having improved stability (shelf life).

### SUMMARY

Embodiments of the present invention comprise a one component adhesive composition that may help overcome one or more of the foregoing discussed problems. In particular, embodiments of the invention provide an epoxy adhesive composition having improved impact resistance at low temperatures, such as −40° C. or less and improved stability resulting in longer shelf life. Preferably, a composite structure prepared with the adhesive has an impact peel strength of at least 15 N/mm at a temperature of minus 40° C., wherein the impact peel strength is measured in accordance with ISO 11343 wedge impact method. The adhesive composition has improved shelf life. Generally, the shelf life is at least 3 months and desirably equal to or more than 6, 12 or 18 months. The shelf life generally means when the initial viscosity of the adhesive composition has increased by 50% when maintained at room temperature (˜23° C.±5° C.) in a sealed container. The viscosity may be determined, for example, by using a Brookfield viscometer using a number 5 spindle or as described below.

In one embodiment composite structures prepared with the inventive adhesive may have impact peel strengths of at least 13 N/mm at a temperature of minus 40° C., wherein the impact peel strength is measured in accordance with ISO 11343 wedge impact method, and preferably the impact peel strength is at least 15 N/mm, and more preferably, at least 20 N/mm.

A first aspect of the invention is a one component adhesive composition comprising an epoxy resin, a polyurethane based toughener, an epoxy capped toughener comprised of a polymer backbone capped with an epoxy, wherein the polymer backbone is at least partially immiscible in the epoxy resin, and an epoxy curing agent.

In one embodiment, the epoxy resin includes at least one diglycidyl ether of a bisphenol. The amount of epoxy resin may be from about 30 to 60 weight percent, based on the total weight of the adhesive composition.

In one embodiment, polyurethane based toughener includes aliphatic diisocyanate groups that are blocked or capped with one or more of Bisphenol A or diisopropyl amine. Preferably, the polyurethane based toughener is a reaction product of an aliphatic diisocyanate and a polyol having a molecular weight ranging between 2,000 and 12,000 Daltons. The amount of polyurethane may range from about 10 to 25 weight percent, based on the total weight of the adhesive composition

In one embodiment, the epoxy capped toughener polymer backbone comprises a block copolymer of one or more of ethylene oxide and propylene oxide and at least one further alkylene oxide containing at least four C atoms. Preferably, the alkylene oxide block comprises tetramethylene oxide.

In one embodiment the epoxy capped toughener polymer backbone is comprised of a homopolymer of polyether of an alkylene oxide having at least 4 carbons or a homopolymer of a polyolefin such as polybutadiene.

The amount of epoxy capped toughener may range from about 2 to 14 weight percent, based on the total weight of the adhesive composition.

In some embodiments, the adhesive may comprise at least one filler, such as mineral fillers, glass particles, and fused silica. The adhesive may also include curing promoting and accelerating agents.

A second aspect of the invention is directed to a composite structure comprising a first substrate, a second substrate, and a cured adhesive composition of the first aspect of the present invention that adhesively bonds the first and second substrates together. The substrates may be the same material or comprise materials that are different from each other. For example, in one embodiment, the first and second substrates may both be metal. In other embodiments, one of the first and second substrates is metal, and the other substrate is plastic.

Aspects of the invention are also directed to methods of joining materials. In one embodiment, a method is provided comprising applying the inventive adhesive to surfaces of two substrates, and curing the adhesive to form an adhesive bond.

Another aspect of the invention is a method of forming an epoxy capped toughener comprising;
(i) reacting a polyol that is comprised of a polymer backbone comprised of a polyether homopolymer of an alkylene oxide having at least 4 carbons or a polyolefin homopolymer with a cyclic anhydride, wherein the anhydride is provided in stoichiometric excess of the polyol's hydroxyls such that the hydroxyls form a carboxylic acid capped polymer, and
(ii) reacting the carboxylic acid groups of the carboxylic capped polymer with a stoichiometric excess of epoxy resin having at least two epoxides per epoxy resin molecule to form the epoxy capped toughener having epoxide end groups.

### DETAILED DESCRIPTION

As discussed previously, embodiments of the present invention are directed to a one component epoxy based adhesive composition comprising one or more epoxy resins; one or more polyurethane based tougheners; one or more epoxy capped tougheners comprised of a polymer backbone capped with an epoxy, wherein the polymer backbone is at least partially immiscible in the epoxy resin, one or more epoxy curing agents.

### Epoxy Resin

The adhesive contains at least one epoxy resin. All or part of the epoxy resin may be present in the form of a rubber-modified epoxy resin, as discussed more below. A wide range of epoxy resins can be used; including those described at column 2 line 66 to column 4 line 24 of U.S. Pat. No. 4,734,332, incorporated herein by reference.

Suitable epoxy resins include the diglycidyl ethers of polyhydric phenol compounds such as resorcinol, catechol, hydroquinone, bisphenol, bisphenol A, bisphenol AP (1,1-bis(4-hydroxylphenyl)-1-phenyl ethane), bisphenol F, bisphenol K, bisphenol M, tetramethylbiphenol, diglycidyl ethers of aliphatic glycols and polyether glycols such as the diglycidyl ethers of C₂₋₂₄ alkylene glycols and poly(ethylene oxide) or poly(propylene oxide) glycols; polyglycidyl ethers of phenol-formaldehyde novolac resins, alkyl substituted phenol-formaldehyde resins (epoxy novalac resins), phenol-hydroxybenzaldehyde resins, cresol-hydroxybenzaldehyde resins, dicyclopentadiene-phenol resins and dicyclopentadiene-substituted phenol resins, and any combination thereof.

Suitable diglycidyl ethers include diglycidyl ethers of bisphenol A resins such as are sold by Olin Corporation under the designations D.E.R. 330, D.E.R. 331, D.E.R.® 332, D.E.R. 383, D.E.R. 661 and D.E.R. 662 resins.

Commercially available diglycidyl ethers of polyglycols include those sold as D.E.R. 732 and D.E.R. 736 by Olin Corporation.

Epoxy novolac resins may also be used. Such resins are available commercially as D.E.N. 354, D.E.N. 431, D.E.N. 438 and D.E.N. 439 from Olin Corporation.

Other suitable additional epoxy resins are cycloaliphatic epoxides. A cycloaliphatic epoxide includes a saturated carbon ring having an epoxy oxygen bonded to two vicinal atoms in the carbon ring, as illustrated by the following structure I:

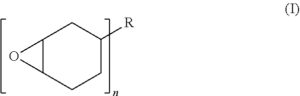

wherein R is an aliphatic, cycloaliphatic and/or aromatic group and n is a number from 1 to 10, preferably from 2 to 4. When n is 1, the cycloaliphatic epoxide is a monoepoxide. Di- or epoxy resins are formed when n is 2 or more. Mixtures of mono-, di- and/or epoxy resins can be used. Cycloaliphatic epoxy resins as described in U.S. Pat. No. 3,686,359 may be used in embodiments of the present invention. Cycloaliphatic epoxy resins of particular interest are (3,4-epoxycyclohexyl-methyl)-3,4-epoxy-cyclohexane carboxylate, bis-(3,4-epoxycyclohexyl) adipate, vinylcyclohexene monoxide and mixtures thereof.

Other suitable epoxy resins may include oxazolidone-containing compounds as described in U.S. Pat. No. 5,112,932. In addition, an advanced epoxy-isocyanate copolymer such as those sold commercially as D.E.R. 592 and D.E.R. 6508 (Olin Corporation) can be used.

The epoxy resin preferably is a bisphenol-type epoxy resin or mixture thereof with up to 10 percent by weight of another type of epoxy resin. Preferably the bisphenol type epoxy resin is a liquid epoxy resin or a mixture of a solid epoxy resin dispersed in a liquid epoxy resin. The most preferred epoxy resins are bisphenol-A based epoxy resins and bisphenol-F based epoxy resins.

An especially preferred epoxy resin is a mixture of a diglycidyl ether of at least one polyhydric phenol, preferably bisphenol-A or bisphenol-F, having an epoxy equivalent weight of from 170 to 299, especially from 170 to 225, and at least one second diglycidyl ether of a polyhydric phenol, again preferably bisphenol-A or bisphenol-F, this one having an epoxy equivalent weight of at least 300, preferably from 310 to 600. The proportions of the two types of resins are preferably such that the mixture of the two resins has an average epoxy equivalent weight of from 225 to 400. The mixture optionally may also contain up to 20%, preferably up to 10%, of one or more other epoxy resin.

In embodiments of the present invention, the epoxy resin may be included at an amount of at least about 10 weight percent, based on the total weight of the adhesive composition, preferably at least about 15 weight percent, and most preferably at least about 20 weight percent, based on the total weight of the adhesive composition. In some embodiments, the epoxy resin preferably comprises up to about 70 weight percent of the adhesive composition, more preferably up to about 60 weight percent, and most preferably up to about 50 weight percent, based on the total weight of the adhesive composition.

### Epoxy Capped Toughener

The epoxy capped polymer comprises a polymer or copolymer backbone in which at least a portion of the polymer backbone has at least one block segment that is immiscible with the epoxy resin. The polymer backbone may contain some portion that is miscible such as block segments which are miscible in epoxy resin such as polyethylene oxide, polypropylene oxide, poly(ethylene oxide-co-propylene oxide), and poly(ethylene oxide-ran-propylene oxide) blocks, and mixtures thereof, so long as they have sufficient immiscibility to cause phase separation in the cured epoxy adhesive to realize the desired toughening. It is preferred that the immiscibility is such that the epoxy capped toughener forms sub-micrometer domains within the cured epoxy, which is believed to be a result of forming micelles during the curing of the adhesive. The toughener, because it also is comprised of groups that react with the epoxy, it will react and become a part of the epoxy thermoset matrix.

Examples of polymer backbones which may be present as block segments within the polymer backbone or as a homopolymer that are immiscible in epoxy resin may include in polyether prepared from alkylene oxides which contain at least four C atoms, preferably tetramethylene oxide, butylene oxide, hexylene oxide, and/or dodecylene oxide. An example of a homopolymer that is useful to make the epoxy capped toughener is a polytetramethylene ether glycol available from INVISTA, Wichita, Kans. under the tradename TERATHANE. Examples of polymer backbones that are immiscible in epoxy resin also may include, olefin polymers, also called polyolefins, that are based on monomer molecules that are unsaturated aliphatic hydrocarbons containing one double bond per molecule (e.g., polyethylene, polyethylene-propylene, polybutadiene, polyisoprene) and polydimethylsiloxane or polyalkyl methacrylate and mixtures of these. An example of a homopolymer of a polyolefin that is useful to make the epoxy capped toughener is a hydroxyl terminated polybutadiene resin available from Cray Valley USA, LLC, Exton, Pa. under the trade name POLY BD.

In an embodiment, the epoxy capped toughener comprises a block copolymer of ethylene oxide and/or propylene oxide and at least one further alkylene oxide containing at least four C atoms, preferably from the group comprising butylene oxide, hexylene oxide, and dodecylene oxide. In another embodiment, the epoxy capped toughener is comprised of a polymer backbone that is an immiscible homopolymer described above. In another embodiment, the epoxy capped toughener is a mixture comprising at least two epoxy tougheners having differing polymer backbones such as those described above. In a particular embodiment the mixture of epoxy tougheners is comprised of a first such toughener where the polymer backbone is comprised of a polyether and a second such toughener where the polymer backbone is comprised of a polyolefin. In a particular embodiment, the first toughener is a homopolymer of a polyether having at least 4 carbon atoms such as poly(tetramethylene oxide) and the second toughener is comprised of homopolymer of a polyolefin such as polybutadiene.

In some embodiments, the epoxy capped toughener polymer backbone may be selected from the group comprising poly(isoprene block-ethylene oxide) block copolymers (PI-b-PEO), poly(ethylene-propylene-b-ethylene oxide) block copolymers (PEP-b-PEO), poly(butadiene-b-ethylene oxide) block copolymers (PB-b-PEO), poly(isoprene-b-ethylene oxide-b-isoprene) block copolymers (PI-b-PEO-PI), poly(isoprene-b-ethylene oxide-methyl methacrylate) block copolymers (PI-b-PEO-b-PMMA), and poly(ethylene oxide)-b-poly(ethylene-alt-propylene) block copolymers (PEO-PEP).

The epoxy capped toughener polymer backbone may be present in particular in diblock, triblock, or tetrablock form. For multiblocks, i.e., in particular for tri- or tetrablocks, these may be present in linear or branched, in particular in star block, form.

Examples of block copolymers that may be used in embodiments of the invention include those described in WO 2006/052725 A1, WO 2006/052726 A1, WO 2006/052727 A1, WO 2006/052728 A1, WO 2006/052729 A1, WO 2006/052730 A1, or WO 2005/097893 A1. A particularly preferred class of block copolymers useful to make the epoxy capped tougher is available from Olin Corporation under the trade name FORTEGRA™. These are capped with carboxylic acid groups, which are reacted further capped with an epoxy as described below.

The preparation of the epoxy capped toughener may be formed by reacting a polymer or copolymer having hydroxyl or carboxylic acid terminal groups such as those described above. When starting with a hydroxyl terminated polymer or copolymer (i.e., polyol), the hydroxyls of the polyol are first reacted with a stoichiometric excess of cyclic anhydride to ensure all of the hydroxyls are terminated with a carboxylic acid group. Typically the stoichiometric excess is from about 1.01 to 1.4 anhydride/OH groups. Generally, the reaction is performed at an elevated temperature from about 50 to 150° C. for a sufficient time (e.g., 10 minutes to 2, 3, 5 or 10 hours) to essentially react all of the hydroxyls in the presence of an aromatic amine catalyst under N₂ protection to form an ester linkage and carboxylic acid terminating group from the reaction product of the anhydride and hydroxyl. The aromatic amine may be, for example, benzyldimethylamine, pyridine, N,N-dimethylaniline (DMA). The amount of amine catalyst ranges from 0.2-0.5 weight percent of all reagents. Any excess anhydride or catalyst need not be stripped out but may be if desired. The end point of the reaction may be determined by infrared spectroscopy showing the formation of ester groups at ˜1735 cm−1 and loss of anhydride bonds at 1858 and 1772 cm−1 in the IR spectra and the acid number typically is from 0.8-1.3 meq/g in accordance with ASTM 4662 except that a lower concentration of KOH solution should be used (0.01M) and the solvent should be methanol.

The carboxylic acid terminated polymer is then reacted with an epoxy having at least two epoxy groups such as those described above at a substantial stoichiometric excess of epoxy/carboxylic groups such as 10/1 to 2/1. The reaction is typically carried out at an elevated temperature from about 80 to 200° C. for a time to realize a desired epoxy equivalent weight (EEW), which illustratively is desirably from about 200 to 1000 g/equivalent. After the reaction, the epoxy capped toughener generally contains a substantial amount of free epoxy molecules, which may vary over a wide range, but typically is from about 25% to 75% of the epoxy capped toughener.

### Polyurethane Based Toughener

In one embodiment, the polyurethane based toughener comprises a polyurethane polymer that is a reaction product of a polyol and an aliphatic diisocyanate, such as 1,6 hexane diisocyanate and isophorone diisocyanate. Preferably, polyurethane based tougheners in accordance with the present invention include end groups that are either reactive toward the epoxy curatives, or are removed so that the isocyanate groups are available to react with the epoxy curatives.

Examples of diisocyanates that may be used in the preparation of the polyurethane polymer include aromatic diisocyantes, toluene diisocyanate (TDI) and methylene diphenyl diisocyanate, MDI, aliphatic and cycloaliphatic isocyanates, such as 1,6-hexamethylene diisocyanate (HDI), 1-isocyanato-3-isocyanatomethyl-3,5,5-trimethyl-cyclohexane (isophorone diisocyanate, IPDI), and 4,4′-diisocyanato dicyclohexylmethane, (H₁₂MDI or hydrogenated MDI).

The polyol component may comprise polyether polyols, which are made by the reaction of epoxides with an active hydrogen containing starter compounds, or polyester polyols, which are made by the polycondensation of multifunctional carboxylic acids and hydroxyl compounds.

In one embodiment, the isocyanate groups of the polyurethane-based toughener may be capped or blocked with an end group, such as a phenolic compound, an aminophenolic compound, carboxylic acid group, or hydroxyl group. Preferred capping groups include phenolic compounds, such as bisphenol-A, or diallyl bisphenol-A and diisopropylamine.

In order for the adhesive composition to have a desired impact resistance at low temperatures (e.g., at and below −40° C.), it has been discovered that it is preferable that the polyurethane toughener comprise a polyol component having good flexibility.

In particular, it has been discovered that polyol components having relatively high molecular weights may provide improved flexibility. In one embodiment, the polyol may have a molecular weight ranging between 2,000 and 12,000 Daltons, and in particular, between 3,000 and 10,000. In one embodiment, it may be desirable for the polyol component to comprise polyether chains having at least 4 consecutive carbon atom between each pair of ether groups, or polyols comprising hydrocarbon chains, or mixtures thereof may provide the desired flexibility. In one embodiment, the polyol comprises a polyether chain having from 4-12 consecutive carbon atoms between each pair of ether groups, and preferably having from 4-8 consecutive carbon atoms between each pair of ether groups.

The polyol component of the polyurethane based toughener may range from about 70 to 90 weight percent, based on the total weight of the polyurethane based toughener. Preferably, the polyol component of the polyurethane based toughener is from about 72 to 88 weight percent, and more preferably, from about 75 to 85 weight percent, based on the total weight of the polyurethane based toughener.

General methods for preparing these polyurethane tougheners are described, for example, in U.S. Pat. No. 5,278,257, WO 2005/118734, U.S. Published Patent Application No. 2005/0070634, U.S. Pat. Nos. 7,910,656, 8,404,707, EP 1 602 702A and EP-A-0 308 664, all of which are incorporated by reference in their entireties. Some exemplary tougheners include bis-phenol blocked polyurethane such as RAM 1087, RAM 965 an isocyanate-terminated polyurethane prepolymer prepared from a polyether polyol and an aliphatic diisocyanate, in which the isocyanate groups are capped with o,o-diallyl bisphenol A, and is made as described in Example 13 of EP 308 664, an isocyanate-terminated polyurethane prepolymer prepared from a polyether polyol and an aliphatic diisocyanate, in which the isocyanate groups are capped with bisphenol A, further described as Toughener B in U.S. Published Patent Application No. 2005/0070634.

The amount of the polyurethane based toughener generally ranges from about 10 to 25 weight percent, based on the total weight of the adhesive composition, and in particular, from about 10 to 20, and more particularly, from about 14 to 18 weight percent, based on the total weight of the adhesive composition. For example, in embodiments of the present invention the adhesive may include up to about 25, up to about 20, up to about 18, up to about 16, or up to about 14 weight percent, of the polyurethane based toughener, based on the total weight of the adhesive composition.

### Curing Agent and Catalyst

The adhesive further contains a curing agent. The curing agent causes the adhesive to cure (cross-link) when heated to a temperature of at least 80° C., preferably at least 100° C. or greater, but does not cause the adhesive to cure or the adhesive cures very slowly at room temperature (about 22° C.) or even at temperatures up to at least 50° C. Suitable curing agents include boron trichloride/amine and boron trifluoride/amine complexes, dicyandiamide, melamine, diallylmelamine, guanamines such as acetoguanamine and benzoguanamine, aminotriazoles such as 3-amino-1,2,4-triazole, hydrazides such as adipic dihydrazide, stearic dihydrazide, isophthalic dihydrazide, semicarbazide, cyanoacetamide, and aromatic polyamines such as diaminodiphenylsulphones. The use of dicyandiamide, isophthalic acid dihydrazide, adipic acid dihydrazide and 4,4′-diaminodiphenylsulphone is particularly preferred.

The curing agent is used in sufficient amount to cure the adhesive. The curing agent typically constitutes at least about 1.5 weight percent of the structural adhesive, and may be at least about 2.5 weight percent. The curing agent desirably constitutes up to about 15 weight percent of the adhesive, more preferably up to about 10 weight percent, and most preferably up to about 6 weight percent.

The one component adhesive may contain a catalyst for accelerating the cure of the adhesive. Like the curing agent the catalyst is latent in the same way as the curing agent in that it catalyzes the adhesive cure upon heating as described above. Among preferred epoxy catalysts are ureas such as p-chlorophenyl-N,N-dimethylurea (Monuron), 3-phenyl-1,1-dimethylurea (Phenuron), 3,4-dichlorophenyl-N,N-dimethylurea (Diuron), N-(3-chloro-4-methylphenyl)-N′,N′-dimethylurea (Chlortoluron), tert-acryl- or alkylene amines like benzyldimethylamine, 2,4,6-tris(dimethylaminomethyl)phenol, piperidine or derivates thereof, imidazole derivatives, in general C.sub.1-C.sub.12 alkylene imidazole or N-arylimidazols, such as 2-ethyl-2-methylimidazol, or N-butylimidazol, 6-caprolactam, a preferred catalyst is 2,4,6-tris(dimethylaminomethyl)phenol integrated into a poly(p-vinylphenol) matrix (as described in European patent EP 0 197 892). The catalyst may be encapsulated or otherwise be a latent type which becomes active only upon exposure to elevated temperatures. Preferably, the catalyst is present in the adhesive composition in the amount of at least about 0.1 weight percent of the structural adhesive, and most preferably at least about 0.2 weight percent. Preferably, the epoxy curing catalyst is present in an amount of up to about 2 weight percent of the structural adhesive, more preferably up to about 1.0 weight percent, and most preferably up to about about 0.7 weight percent. Another optional component is a bisphenol compound that has two or more, preferably two, phenolic hydroxyl groups per molecule. Examples of suitable bisphenol compounds include, for example, resorcinol, catechol, hydroquinone, bisphenol, bisphenol A, bisphenol AP (1,1-bis(4-hydroxylphenyl)-1-phenyl ethane), bisphenol F, bisphenol K, tetramethylbiphenol and the like. The bisphenol component can be dissolved into the structural adhesive composition or present in the form of finely divided particles. Preferably, the bisphenol component is pre-reacted with an epoxy resin (which may include a rubber-modified epoxy resin, if present) to advance the resin somewhat.

If used, the bisphenol component is preferably used in an amount from about 3 to about 35 parts by weight per 100 parts by weight of the rubber component. A preferred amount is from about 5 to about 25 parts by weight per 100 parts by weight of the rubber component. When the bisphenol component is added directly into the structural adhesive, it usually constitutes from 0.25 to 2 weight percent, especially 0.4 to 1.5 weight percent, of the adhesive.

### Other Components

The adhesive of the invention may contain various other optional components. Among these, fillers, rheology modifiers or pigments, one or more additional epoxy resins and other tougheners such as rubber tougheners such as such as carboxyl-terminated butadiene-acrylonitrile copolymers commonly referred to as CTBN rubber tougheners may be used.

A filler, rheology modifier and/or pigment are typically useful in the structural adhesive. These can perform several functions, such as (1) modifying the rheology of the adhesive in a desirable way, (2) reducing overall cost, (3) absorbing moisture or oils from the adhesive or from a substrate to which it is applied, and/or (4) promoting cohesive, rather than adhesive, failure. Examples of these materials include calcium carbonate, calcium oxide, talc, coal tar, carbon black, textile fibers, glass particles or fibers, aramid pulp, boron fibers, carbon fibers, mineral silicates, mica, powdered quartz, hydrated aluminum oxide, bentonite, wollastonite, kaolin, fumed silica, silica aerogel or metal powders such as aluminum powder or iron powder. Among these, calcium carbonate, talc, calcium oxide, fumed silica and wollastonite are preferred, either singly or in some combination, as these often promote the desired cohesive failure mode.

The adhesive composition can further contain other additives such as diluents, plasticizers, extenders, pigments and dyes, fire-retarding agents, thixotropic agents, flow control agents, thickeners such as thermoplastic polyesters, gelling agents such as polyvinylbutyral, adhesion promoters and antioxidants.

Fillers, rheology modifiers, gelling agents, thickeners and pigments preferably are used in an aggregate amount of about 5 weight percent, based on the total weight of the adhesive composition or greater, more preferably about 10 weight percent of the adhesive composition or greater. In one embodiment, such components may preferably be present in an amount of up to about 25 weight percent of the adhesive, more preferably up to about 20 weight percent.

The adhesive composition can be applied by any convenient technique. It can be applied cold or be applied warm if desired. It can be applied by extruding it from a robot into bead form on the substrate, it can be applied using manual application methods such as a caulking gun, or any other manual application means. The structural adhesive can also be applied using jet spraying methods such as a steaming method or a swirl technique. The swirl technique is applied using an apparatus well known to one skilled in the art such as pumps, control systems, dosing gun assemblies, remote dosing devices and application guns. The adhesive may be applied to the substrate using a streaming process. Generally, the adhesive is applied to one or both substrates. The substrates are contacted such that the adhesive is located between the substrates to be bonded together.

After application, the adhesive may be cured by heating to a temperature at which the curing agent initiates cure of the epoxy resin composition. Generally, this temperature is about 80° C. or above, preferably 100° C. or above. Preferably, the temperature is about 220° C. or less, and more preferably about 180° C. or less.

The adhesive of the invention can be used to bond a variety of substrates together including wood, metal, coated metal, aluminum, a variety of plastic and filled plastic substrates, fiberglass and the like. In one preferred embodiment, the adhesive is used to bond parts of automobiles together or parts to automobiles. Such parts can be steel, coated steel, galvanized steel, aluminum, coated aluminum, plastic, fiber composites (e.g., carbon or glass fiber impregnated with epoxy resin composites) and filled plastic substrates.

An application of particular interest is bonding of automotive frame components to each other or to other components. The frame components are often metals such as cold rolled steel, galvanized metals, or aluminum. The components that are to be bonded to the frame components can also be metals as just described, or can be other metals, plastics, composite materials, and the like.

Adhesion to brittle metals such as steel coated with galvanneal is of particular interest in the automotive industry. Galvanneal tends to have a zinc-iron surface that is somewhat rich in iron content and is brittle for that reason. A particular advantage of this invention is that the cured adhesive bonds well to metals with a brittle coating, such as galvanneal. Another application of particular interest is the bonding of aerospace components, particularly exterior metal components or other metal components that are exposed to ambient atmospheric conditions during flight.

The adhesive composition once cured preferably has a Young's modulus of about 1000 MPa as measured according to DIN EN ISO 527-1. More preferably, the Young's modulus is about 1200 MPa or greater. Preferably, the cured adhesive demonstrates a tensile strength of about 25 MPa or greater, more preferably about 30 MPa or greater, and most preferably about 35 MPa or greater. Preferably, the lap shear strength of a 1.5 mm thick cured adhesive layer is about 15 MPa or greater, more preferably about 20 MPa or greater, and most preferably about 25 MPa or greater measured according to DIN EN 1465.

### EXAMPLES

In the following Examples, a one-component adhesive in accordance with embodiments of the invention was prepared and evaluated in comparison to a comparative adhesive that did not include epoxy capped toughener.

### Synthesis of Epoxy Capped Tougheners

The ingredients in Table 1 were reacted as follows to form the epoxy capped tougheners.

### Example 1

100 g of MTHPA, 462 g of TERATHANE 2000 polyol and 1.7 g of benzyl dimethyl amine were charged into a round bottom flask. The mixture was stirred at 110° C. for 2 hours under N₂ to form an acid capped PTMEG polyol and the product was allowed to cool to 80° C. before discharge. The reaction was stopped when the formation of ester groups at ˜1735 cm−1 and loss of anhydride bonds at 1858 and 1772 cm−1 was observed in the IR spectra and the acid number was determined to be 1.13 meq/g in accordance with ASTM 4662 except that a lower concentration of KOH solution was used (0.01M) and the solvent was methanol.

### Example 2

66.5 g of MTHPA, 350 g of PolyBD polyol and 1.7 g of benzyl dimethyl amine were charged into a round bottom flask. The mixture was stirred at 110° C. for 2 hours under N₂ to form an acid capped PolyBD polyol and the product was allowed to cool to 80° C. before discharge. The reaction was stopped when the formation of ester groups at ˜1735 cm−1 and loss of anhydride bonds at 1858 and 1772 cm−1 was observed in the IR spectra and the acid number was determined to be 0.90 meq/g in accordance with ASTM 4662 except as detailed in Example 1.

### Example 3

50 grams of the acid capped PTMEG polyol (Example 1) and 50 grams of the acid capped PolyBD polyol (Example 2) was charged into a flask with 151.2 g of DER 383, which was then stirred at 120° C. under N₂ until the targeted Epoxy Equivalent Weight (EEW) was reached, which was typically within 2 hours to form this epoxy capped toughener. The EEW of formed epoxy capped toughener was determined to be 356 according to ASTM D1652.

TABLE 1
Ingredients for Epoxy Capped Tougheners.

| Ingredient | Supplier | Description |
|---|---|---|
| TERATHANE ™ | Invista | Polytetramethylene glycol |
| 2000 | | (PTMEG)~2000 MW |
| | | (~Equivalent Weight 1000) |
| POLY BD ™ R- | Cray Valley | Liquid hydroxyl terminated |
| 45HTLO | | polymer of butadiene |
| | | terminated with primary |
| | | allylic alcohol groups. |
| | | Hydroxyl functionality |
| | | 2.4-2.6 and MW ~2800 |
| Methyl | Dixie Chemical | Methyl TetraHydroPhthalic |
| TetraHydroPhthalic | Company Inc. | Anhydride is an unsaturated |
| Anhydride (MTHPA) | | cyclic anhydride with a |
| | | Methyl group |
| DER 383 | Olin | Liquid Epoxy Resin is a |
| | Corporation | reaction product of |
| | | epichlorohydrin and bisphenol |
| | | A. Epoxide Equivalent Weight |
| | | (g/eq) 176-183 |
| Benzyl dimethyl | Aldrich | Catalyst |
| amine | | |

TABLE 2
Adhesive Composition Ingredients:

| Ingredient | Supplier | Description |
|---|---|---|
| RAM965 | Huntsman | Aliphatic based |
| | | urethane prepolymer |
| D.E.R. ™ | Olin | Diglycidyl ether |
| 330 | | of bisphenol A |
| RAM1087 | Huntsman | Epoxysilane-9-[2- |
| | | (2-Methoxyethoxy) |
| | | ethoxy]-9-[3- |
| | | (oxiranylmethoxy) |
| | | propyl]-2,5,8,10,13, |
| | | 16-hexaoxa-9- |
| | | silaheptadecane |
| Cardura ™ | Hexion | Glycidyl Neodecanoate |
| N-10 | | |
| NC-700 | Cardolite | Cashew nut shell liquid |
| Amicure CG-1200 | Air Products | Dicyandiamide |
| Quicklime CaO | Mississippi Lime Co. | Calcium oxide |
| Atomite | Imerys Carbonates | Calcium carbonate |
| Cab-O-Sil | Cabot Corp. | Fumed Silica |
| TS-720 | | |
| EP796 | Dow | Blocked tertiary amine |
| | | curing accelerator |
| Omicure ™ U52-M | Emerald | Micronized dimethylurea |
| | Performance | curing accelerator |
| | Materials | |
| CTBN | Emerald | Carboxyl-terminated |
| | Performance | butadiene-acrylonitrile |
| | Materials | rubber |

TABLE 3
Adhesive Formulations

| | Comp. | Comp. | |
|---|---|---|---|
| | Ex. 1 | Ex. 2 | Ex. 3A |
| Ingredient | (wt %) | (wt %) | (wt %) |
| CTBN | 0 | 7.9 | — |
| RAM965 | 24.3 | 17.2 | 17.2 |
| D.E.R. ™ 330 | 55.9 | 54.4 | 52.3 |
| RAM1087 | 0.68 | 0.68 | 0.68 |
| Cardura ™ N-10 | 1.13 | 1.13 | 1.13 |
| NC-700 | 1.97 | 1.97 | 1.97 |
| Amicure CG-1200 | 5.1 | 5.1 | 5.1 |
| Atomite | 3.59 | 3.59 | 3.59 |
| Quicklime CaO | 3.59 | 3.59 | 3.59 |
| Cab-O-Sil TS-720 | 3 | 3.65 | 3.65 |
| EP796 | 0.75 | 0.75 | 0.75 |
| Example 3 Epoxy | | | 10 |
| Capped Toughener | | | |

TABLE 4
Cured Characteristics of the Adhesive Compositions.

| | | | −40° C. | ~23° C. |
|---|---|---|---|---|
| | Primary | | Impact Peel | Impact Peel |
| Sample ID | Toughener | Co-Toughener | (N/mm) | (N/mm) |
| Comp. Ex. 1 | RAM 965 | CTBN | 26.3 | 35 |
| Comp. Ex. 2 | RAM 965 | None | 27.4 | 34.9 |
| Ex. 3A | RAM 965 | Example 3 | 30.8 | 41.0 |

### Adhesive Composition Examples

The materials used in the adhesive compositions are identified below. All percentages are weight percents unless indicated otherwise. All physical property and compositional values are approximate unless indicated otherwise.

### Comparative Examples 1 and 2

The adhesive of Comparative Example 1 only has a polyurethane toughener (RAM 965). The adhesive of Comparative Example 2 has the RAM 965 polyurethane toughener and a carboxyl terminated butadiene acrylonitrile (CTBN) toughener. These epoxy adhesive compositions were prepared as follows. The epoxy resins and toughener as well as the liquid components of the adhesive formulation shown in Table 3 were added to a mixing cup and mixed by a SpeedMixer™ (DAC400 FVZ-FlackTeK Inc.) at 2200 rpm for 60 seconds. Then Amicure™ CG-1200 Dicy, Quicklime CaO, Atomite, and Cab-O-Sil TS-720 were added to the mixing cup and mixed at 2300 rpm for 3 min. Heat was generated during the mixing process, and the temperature was measured by IR thermometer to ensure that the mixture did not exceed 65° C. After the mixture had cooled below 45° C., EP796 was added and mixed at 2200 rpm for 1 min. After cooling, the adhesive composition was de-aired by mixing the composition in a dual planetary Ross Mixer for 20 minutes at a slow speed and under 25 inches Hg.

### Examples 3A

The same procedure was used to make each of the adhesive composition's 3A as shown for Comparative Examples 1 and 2, but using the ingredients in Table 3 and in particular the epoxy capped tougheners of Example 3. The impact resistance at low-temperature of Example and Comparative Examples were evaluated as follows.

### Impact Peel Coupon Preparation

Impact Peel specimens were prepared and tested according to the ISO Standard ISO 11343. The substrate used was 0.8 mm thick GMC-5E cold rolled steel supplied by ACT Laboratories, Inc. Test coupons were cut into 20 mm×100 mm strips. 10 mil thick Teflon tape was applied to the end and middle of one coupon marking off the bonding area of 20 mm×30 mm. The bonding section of each coupon was cleaned with Acetone. The adhesive was applied to the bonding section of the coupon and another coupon was laid on top to assemble the specimen. The edges of the assembly were scraped clean using a spatula and held together with clips while curing for a 30 minute 170° C. bake cycle in a programmable Blue M Electric Oven programmed with repeatable heat up and cool down cycles. After curing, the bonded section of the assembly was marked and clamped in a vice. The free ends were bent by hand to allow the insertion of a wedge for impact testing.

### Impact Peel Testing

Impact testing was performed with an Instron Dynatup Crush Tower in accordance with ISO 11343 wedge impact method. The specimens were placed inverted on a fixed wedge. The crosshead with the load cell and 50 lb. weight attached was dropped from a fixed height at a velocity of 6.7 ft/s. The cleavage force was measured and converted to N/mm of bond line. Specimens were tested at room temperature (˜23° C.) and at −40° C. To test at minus 40° C., the coupons were placed in a freezer at −43° C. for 1 hour and then removed and immediately tested at room temperature. This procedure ensured that the adhesive and coupon were essentially at minus 40° C. at the instant of impact.

From the results of the impact peel testing shown in Table 4, it is readily apparent that the Example comprised of an epoxy resin, a polyurethane prepolymer (as primary toughener), an epoxy capped toughener of this invention (as co-toughener) and a curing agent results in substantially higher impact resistance at both room temperature and −40° C. than the Comparative Examples, which lack the epoxy capped toughener. This is so even though Comparative Example 1 contains the typical CTBN co-toughener used in these compositions

1. A one-component adhesive composition comprising:
an epoxy resin;
a polyurethane based toughener;
an epoxy capped toughener comprised of a polymer backbone capped with an epoxy, wherein the polymer backbone is at least partially immiscible in the epoxy resin; and
an epoxy curing agent.

2. The adhesive of claim 1, wherein the epoxy resin includes at least one diglycidyl ether of a bisphenol.

3. The adhesive of claim 1, wherein the amount of epoxy resin is from 30 to 60 weight percent, based on the total weight of the adhesive composition

4. The adhesive of claim 1, wherein the polyurethane based toughener includes aliphatic diisocyanate groups that are blocked or capped with one or more of Bisphenol A or diisopropyl amine.

5. The adhesive of claim 1, wherein polyurethane based toughener is a reaction product of an aliphatic diisocyanate and a polyol having a molecular weight ranging between 2,000 and 12,000 Daltons,

6. The adhesive of claim 1, wherein the amount of polyurethane is from 10 to 25 weight percent, based on the total weight of the adhesive composition

7. The adhesive of claim 1, wherein the polymer backbone of the epoxy capped toughener comprises a block copolymer of one or more of ethylene oxide and propylene oxide and at least one further alkylene oxide containing at least four C atoms.

8. The adhesive of claim 7, wherein the alkylene oxide block comprises butylene oxide.

9. The adhesive of claim 1, wherein the amount of epoxy capped toughener is from 2 to 14 weight percent, based on the total weight of the adhesive composition.

10. The adhesive of claim 1, wherein the polymer backbone of the epoxy capped toughener is the polyether and the polyether is a homopolymer of an alkylene oxide having at least 4 carbons.

11. The adhesive of claim 1, wherein the polymer backbone of the epoxy capped toughener has blocks that are immiscible in the epoxy resin and block that are miscible in the epoxy resin.

12. The adhesive of claim 1, wherein the polymer backbone of the epoxy capped toughener is immiscible in the epoxy resin.

13. The adhesive of claim 12, wherein the polymer backbone of the epoxy capped toughener is a polyether homopolymer of an alkylene oxide having at least 4 carbons or a polyolefin homopolymer.

14. The adhesive of claim 1, wherein the epoxy capped toughener has a Tg of less than minus 40° C. and the polymer backbone of the epoxy capped toughener is immiscible in the epoxy resin.

15. A composite structure comprising a first substrate, a second substrate, and a cured adhesive composition of claim 1 joining the first and second substrates together.

16. The composite structure of claim 15, wherein the first and second substrates are both metal.

17. The composite structure of claim 15, wherein one of the first and second substrates is metal, and the other substrate is plastic.

18. The composite structure of claim 15 wherein the composite structure has an impact peel strength of at least 15 N/mm at a temperature of minus 40° C., wherein the impact peel strength is measure in accordance with ISO 11343 wedge impact method.

19. A method of forming an epoxy capped toughener comprising
(i) reacting a polyol that is comprised of a polymer backbone comprised of a polyether homopolymer of an alkylene oxide having at least 4 carbons or a polyolefin homopolymer with a cyclic anhydride, wherein the anhydride is provided in stoichiometric excess of the polyol's hydroxyls such that the hydroxyls form a carboxylic acid capped polymer, and
(ii) reacting the carboxylic acid groups of the carboxylic capped polymer with a stoichiometric excess of epoxy having at least two epoxides per epoxy resin molecule to form the epoxy capped toughener having epoxide end groups.

20. The method of claim 19, wherein the polyol has a polymer backbone comprised of a polyether homopolymer of an alkylene oxide having at least 4 carbons.

21. The method of claim 19, wherein the polyol has a polymer backbone comprised of a polyolefin homopolymer.

22. The method of claim 21, wherein the polyolefin homopolymer is polybutadiene.
